(19) United States
(12) Patent Application Publication
(10) Pub. No.: US 2019/0056841 A1
(43) Pub. Date: Feb. 21, 2019

(54) APPARATUS, METHOD, AND COMPUTER-READABLE STORAGE MEDIUM FOR MOBILE KEYBOARD CONTENT DELIVERY

(71) Applicant: Ante Diem, Inc. d/b/a SportsManias, Miami, FL (US)

(72) Inventors: Vicente Javier Fernandez, Coral Gables, FL (US); Aymara Del Aguila, Coral Gables, FL (US)

(73) Assignee: Ante Diem, Inc. d/b/a SportsManias, Miami, FL (US)

(21) Appl. No.: 15/681,027

(22) Filed: Aug. 18, 2017

(51) Int. Cl. G06F 3/0482; G06F 3/0481; G06F 3/0488; G06F 3/0483

(52) U.S. Cl. CPC G06F 3/0482; G06F 3/04817; H04L 67/34; G06F 3/0483; G06F 3/04886

(57) ABSTRACT

An apparatus, method, and computer-readable storage medium that receive a request from a remote device via a network for updated emoji information, the updated emoji information being configured to populate an emoji keyboard, transmit a file corresponding to the preview emoji icons and enhanced emoji icons in response to the request, transmit the preview emoji icons to the remote device in response to receiving the request for the preview emoji icons, receive a request from the remote device via the network for an enhanced emoji icon, the enhanced emoji icon being an enhanced version of a corresponding preview emoji icon, and transmit the enhanced emoji icon to the remote device via the network in response to receiving the request for the enhanced emoji.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Emoji keyboards typically allow access to a plurality of emojis that can be sent via a messaging application. However, due to local memory constraints, the size and types of emojis can be limited. Additionally, there is limited flexibilty in emoji keyboard functionality which can limit the operation of existing emoji keyboards.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

Embodiments of the disclosed subject matter are directed to an apparatus, method, and computer-readable storage medium for mobile keyboard content delivery. The apparatus includes processing circuitry configured to receive a request from a remote device via a network for updated emoji information, the updated emoji information being configured to populate an emoji keyboard, transmit a file via the network in response to the request for updated emoji information, the file corresponding to the updated emoji information and including emoji listings, the emoji listings corresponding to preview emoji icons and enhanced emoji icons, determine whether a request for the preview emoji icons is received and transmit the preview emoji icons to the remote device via the network in response to receiving the request for the preview emoji icons, receive a request from the remote device via the network for an enhanced emoji icon from the enhanced emoji icons, the enhanced emoji icon being an enhanced version of a corresponding preview emoji icon, the enhanced emoji icon and the corresponding preview emoji icon representing a same content, and transmit the enhanced emoji icon to the remote device via the network in response to receiving the request for the enhanced emoji.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts an exemplary overview of the mobile keyboard content delivery system according to one or more aspects of the disclosed subject matter;

FIG. 2 depicts an exemplary work flow of the mobile keyboard content delivery system according to one or more aspects of the disclosed subject matter;

FIG. 3 depicts an exemplary mobile keyboard according to one or more aspects of the disclosed subject matter;

FIG. 4 depicts an exemplary mobile keyboard with advertisement according to one or more aspects of the disclosed subject matter;

FIG. 5 depicts an exemplary mobile keyboard with additional tabs expanded according to one or more aspects of the disclosed subject matter;

FIG. 6 depicts an exemplary keyboard displaying a temporary advertisement according to one or more aspects of the disclosed subject matter;

FIG. 7 is an algorithmic flow chart for delivering content via a mobile keyboard according to one or more exemplary aspects of the disclosed subject matter;

FIG. 8 is an algorithmic flow chart for delivering content via a server according to one or more exemplary aspects of the disclosed subject matter, and

FIG. 9 is a hardware block diagram of a device (computer, server, or remote device) according to one or more exemplary aspects of the disclosed subject matter.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed subject matter. However, it will be apparent to those skilled in the art that embodiments may be practiced without these specific details. In some instances, well-known structures and components may be shown in block diagram form in order to avoid obscuring the concepts of the disclosed subject matter.

Reference throughout the specification to “one embodiment” or “an embodiment” means that a particular feature, structure, characteristic, operation, or function described in connection with an embodiment is included in at least one embodiment of the disclosed subject matter. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments. Further, it is intended that embodiments of the disclosed subject matter can and do cover modifications and variations of the described embodiments.

It must be noted that, as used in the specification and the appended claims, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the disclosed subject matter to any particular orientation or configuration. Furthermore, terms such as “first,” “second,” “third,” etc., merely identify one of a number of portions, components, points of reference, operations and/or functions as described herein, and likewise do not necessarily limit embodiments of the disclosed subject matter to any particular configuration or orientation.

According to an embodiment, an apparatus comprises: processing circuitry configured to receive a request from a remote device via a network for updated emoji information, the updated emoji information being configured to populate an emoji keyboard, transmit a file via the network in response to the request for updated emoji information, the file corresponding to the updated emoji information and including emoji listings, the emoji listings corresponding to preview emoji icons and enhanced emoji icons, determine whether a request for the preview emoji icons is received, transmit the preview emoji icons to the remote device via the network in response to receiving the request for the preview emoji icons, receive a request from the remote device via the network for an enhanced emoji icon from the enhanced emoji icons, the enhanced emoji icon being an enhanced version of a corresponding preview emoji icon, the enhanced emoji icon and the corresponding preview emoji icon representing a same content, and transmit the enhanced emoji icon to the remote device via the network in response to receiving the request for the enhanced emoji icon.

According to an embodiment, the emoji keyboard includes a plurality of content tabs, each content tab including a predetermined number of preview emoji icons displayed in a predetermined order.

According to an embodiment, the emoji listings include an encrypted Uniform Resource Locator (URL) for each preview emoji icon and each enhanced emoji icon.

According to an embodiment, the enhanced emoji icon is a full size version of the corresponding preview emoji icon, the enhanced emoji icon including one or more of higher quality, larger size, and higher resolution.

According to an embodiment, the enhanced emoji icon is transmitted to a clipboard feature of the remote device, the enhanced emoji icon being pasted from the clipboard feature.

According to an embodiment, the emoji keyboard includes one or more inline banner assets displayed between rows of preview emoji icons.

According to an embodiment, the processing circuitry is further configured to instruct the remote device to display additional content that is different from the content of the preview and enhanced emoji icons, in response to the request for the enhanced emoji icon, the request for the enhanced emoji icon being initiated when the preview emoji icon is selected.

According to an embodiment, the processing circuitry is further configured to instruct the remote device to display the additional content for a predetermined amount of time before returning to a previous state of the emoji keyboard.

According to an embodiment, the additional content is displayed in place of the emoji keyboard.

According to an embodiment, a method comprises: receiving, via processing circuitry, a request from a remote device via a network for updated emoji information, the updated emoji information being configured to populate an emoji keyboard; transmitting, via the processing circuitry, a file via the network in response to the request for updated emoji information, the file corresponding to the updated emoji information and including emoji listings, the emoji listings corresponding to preview emoji icons and enhanced emoji icons; determining, via the processing circuitry, whether a request for preview emoji icons is received; transmitting, via the processing circuitry, the preview emoji icons to the remote device via the network in response to receiving the request for the preview emoji icons; receiving, via the processing circuitry, a request from the remote device via the network for an enhanced emoji icon from the enhanced emoji icons, the enhanced emoji icon being an enhanced version of a corresponding preview emoji icon, the enhanced emoji icon and the corresponding preview emoji icon representing the same content; and transmitting, via the processing circuitry, the enhanced emoji icon to the remote device via the network in response to receiving the request for the enhanced emoji icon.

According to an embodiment, the emoji keyboard includes a plurality of content tabs, each content tab including a predetermined number of preview emoji icons displayed in a predetermined order.

According to an embodiment, the emoji listings include an encrypted Uniform Resource Locator (URL) for each emoji preview icon and each enhanced emoji icon.

According to an embodiment, the enhanced emoji icon is a full size version of the corresponding preview emoji icon, the enhanced emoji icon including one or more of higher quality, larger size, and higher resolution.

According to an embodiment, the method further comprises transmitting the enhanced emoji icon to a clipboard feature of the remote device, the enhanced emoji icon being pasted from the clipboard feature.

According to an embodiment, the emoji keyboard includes one or more inline banner assets displayed between rows of the preview emoji icons.

According to an embodiment, the method further comprises displaying additional content that is different from the content of the preview and enhanced emoji icons in the emoji keyboard, in response to the request for the enhanced emoji icon, the request for the enhanced emoji icon being initiated when the preview emoji icon is selected.

According to an embodiment, the method further comprises displaying the additional content for a predetermined amount of time before returning to a previous state of the emoji keyboard.

According to an embodiment, the additional content is displayed in place of the emoji keyboard.

According to an embodiment, a non-transitory computer-readable storage medium stores computer-readable instructions thereon which, when executed by a computer, cause the computer to perform a method, the method comprising: receiving a request from a remote device via a network for updated emoji information, the updated emoji information being configured to populate an emoji keyboard; transmitting a file via the network in response to the request for updated emoji information, the file corresponding to the updated emoji information and including emoji listings, the emoji listings corresponding to preview emoji icons and enhanced emoji icons; determining whether a request for preview emoji icons is received; transmitting the preview emoji icons to the remote device via the network in response to receiving the request for the preview emoji icons; receiving a request from the remote device via the network for an enhanced emoji icon from the enhanced emoji icons, the enhanced emoji icon being an enhanced version of a corresponding preview emoji icon, the enhanced emoji icon and the corresponding preview emoji icon representing the same content; and transmitting the enhanced emoji icon to the remote device via the network in response to receiving the request for the enhanced emoji icon.

According to an embodiment, the emoji keyboard includes a plurality of content tabs, each content tab including a predetermined number of preview emoji icons displayed in a predetermined order, and the emoji listings include an encrypted URL for each emoji preview icon and each enhanced emoji icon.

Referring now to the drawings, wherein like reference numerals designate identical or corresponding parts throughout the several views.

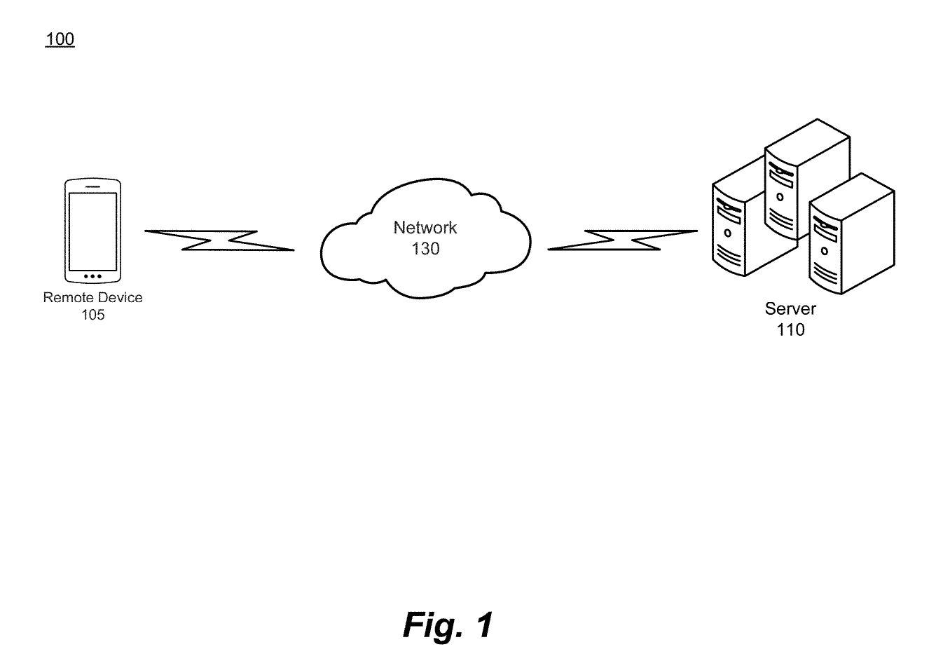

FIG. 1 depicts an exemplary overview of the mobile keyboard content delivery system 100 (herein system 100) according to one or more aspects of the disclosed subject matter. The system 100 can include a remote device 105 communicably coupled to a server 110 via a network 130.

The remote device 105 can represent one or more remote devices connected to the server 110 via the network 130. The remote device 105 can include a front-end application (e.g., an app installed on a device) as a keyboard extension and/or alternate keyboard (e.g., emoji keyboard). An emoji can be a digital image, icon, and/or animation used to express an idea, emotion, and the like in electronic communication. In other words, an emoji represents (particular) content. The remote device 105 can be a smart phone, a computer, a laptop, a tablet, a PDA, and the like. The remote device 105 can include processing circuitry to independently operate and/or assist in operating the system 100. The remote device 105 can include an interface, such as a digital and/or physical keyboard and/or a mouse and/or touch-based input functionality, allowing an operator, for example, to interact with the front-end application of the remote device 105.

The server 110 can represent one or more servers connected to the remote device 105 via the network 130. The server 110 can include processing circuitry to perform various processing for the system 100 including receiving requests from the remote device 105 via the network 130. Additionally, the server 110 can transmit information to the remote device 105 via the network 130. For example, the server 110 can include a back-end content management system (CMS) that contains and organizes all of the dynamic content displayed in the front-end application. Additionally, the dynamic content contained and organized by the back-end CMS can be customized. The customizable content can include a structure of content divided into tabs. For example, each tab can be associated with a specific theme. Tab information including a name of the tab and an icon associated with the tab can be customized. Further, determining which emojis will be displayed, as well as the order in which the emojis will be displayed can be customized via the back-end CMS. Note that an emoji is represented by an emoji icon/image, for example, and emoji/emoji icon/image may be used interchangeably herein. Additionally, sponsorship assets displayed within the keyboard extension can be customized. The sponsorship assets can include an inline banner asset displayed within the list of emojis, as well as a “cut and paste” banner asset that is displayed in response to an emoji being selected. The sponsorship asset parameters to be customized can include a location of the inline banner, as well as how many inline banners should be displayed throughout each tab in the emoji keyboard. For example, the inline banner asset can be displayed across the length of the emoji keyboard after every four rows of emojis. Additionally, the “cut and paste” banner asset can be displayed for a predetermined amount of time after an emoji is selected. For example, the “cut and paste” banner asset can be displayed for three seconds before reverting to the previous state of the emoji keyboard.

The network 130 can represent one or more networks connecting the remote device 105 and the server 110. The network 130 can be a public network, such as the Internet, or a private network such as a local area network (LAN) or a wide area network (WAN) network, or any combination thereof and can also include a public switched telephone network (PSTN) or integrated services for digital network (ISDN) sub-networks. The network 130 can also be wired, such as an Ethernet network or a USB port, or can be wireless such as a cellular network including EDGE, 3G 4G, and LTE/LTE-A wireless cellular systems. The wireless network can also be Wi-Fi, Bluetooth, or any other wireless form of communication that is known.

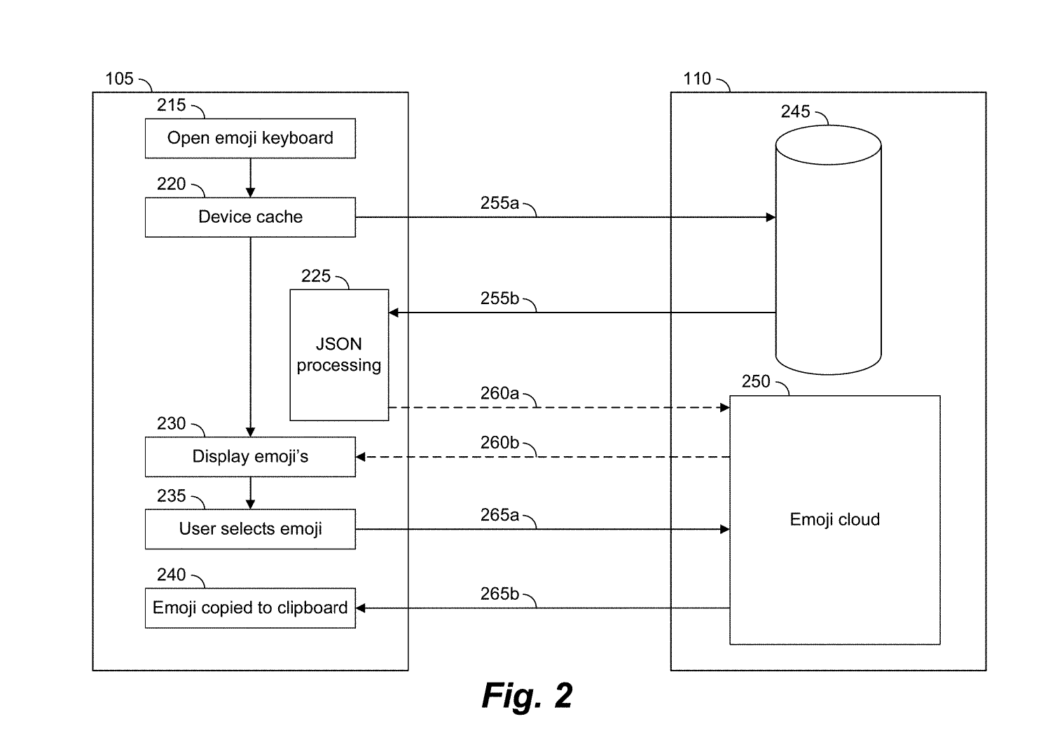

FIG. 2 depicts an exemplary work flow of the system 100 according to one or more aspects of the disclosed subject matter. More specifically, the emoji keyboard installed via the front-end application of the remote device 105 includes a visual layout of a row of buttons positioned along a bottom of the keyboard which control various actions of the keyboard, as further described herein. The first time the emoji keyboard is activated, a request is made to the server 110 to retrieve the latest content available and refreshes with the new data. After the initial download of emojis, the emojis are cached within the mobile application. Data caching is used to ensure that the content is only updated when new content is available as to not disrupt the user experience. The emoji keyboard utilizes two sizes for each emoji including a smaller preview size displayed in the keyboard to reduce memory consumption and to allow for more emojis to be previewed simultaneously without memory issues. When an emoji is selected to be shared, a larger asset with better quality and resolution is actually shared, as further described herein. For example, the emoji preview size may be 90 pixels by 90 pixels. This size may be set by the design as well as in consideration of hardware limitations. The larger asset size may be 120 pixels by 120 pixels, for example. However, the size of the larger asset is not limited and may be changed depending on which app the emoji is sent on, for example (e.g., Instagram, Facebook messenger, iMessage, etc.).

When the emoji keyboard is opened 215 (e.g., when a user selects the emoji keyboard via a mobile app of a mobile device 105, for example), cached emojis are displayed (e.g., display emojis 230) via device cache 220. Additionally, a request 255a can be made to a cloud based emoji server (e.g., server 110). The server 110 may include a database 245 and an emoji cloud server 250. More specifically, the request 255a may be made to the database 245 requesting a JavaScript Object Notation (JSON) file containing the latest full tab and emoji listings. The server 110 may transmit the most recent JSON file via a reply 255b. The emoji listings may include an encrypted Uniform Resource Locator (URL) for each emoji preview as well as each full size (or enhanced) emoji. The JSON file can be processed at the remote device 105 in the JSON processing 225. If the received JSON file transmitted via reply 255b is the same as the JSON file (e.g., the JSON files have the same version number) that was previously sent by the server 110 the last time the emoji keyboard was opened, then the cached emojis of the emoji keyboard remain unchanged. In other words, the remote device 105 maintains cached emojis unless it is determined that there is a new version of the JSON file. However, if the received JSON file is new, the corresponding new emoji previews are requested from the emoji cloud 250 via request 260a, and the emoji cloud 250 replies with the requested emoji previews via reply 260b. In response to the reply 260b, the remote device 105 can display the new emoji previews (e.g., display emojis 230).

A user can then select an emoji from the emoji previews (e.g., user selects emoji 235). When a user selects an emoji from the emoji previews, a URL corresponding to the full size emoji can be used to request the full size emoji from the emoji cloud 250 via request 265a. The emoji cloud 250 can reply to request 265a via reply 265b. The URL corresponding to the full size emoji can be used to copy the full size emoji to a clipboard (e.g., emoji copied to clipboard 240). The clipboard can be available via the existing operating system and/or app of the remote device 105. All of the full size emoji URLs are available because they were included in the JSON file transmitted via reply 255b, for example. More specifically, the JSON file does not include each individual preview and enhanced emoji icon, but rather includes a URL link to each preview and enhanced emoji icon. As a result, the JSON file itself is much smaller and easier to transfer via the network, which can reduce the possibility of the emoji keyboard crashing, for example, and increase system flexibility. In other words, a user can select an emoji from the preview emojis being displayed via the emoji keyboard. When the user selects one of the preview emojis, the corresponding full size emoji with better quality and resolution is requested via its corresponding URL link, copied to the clipboard, and is ready to be shared.

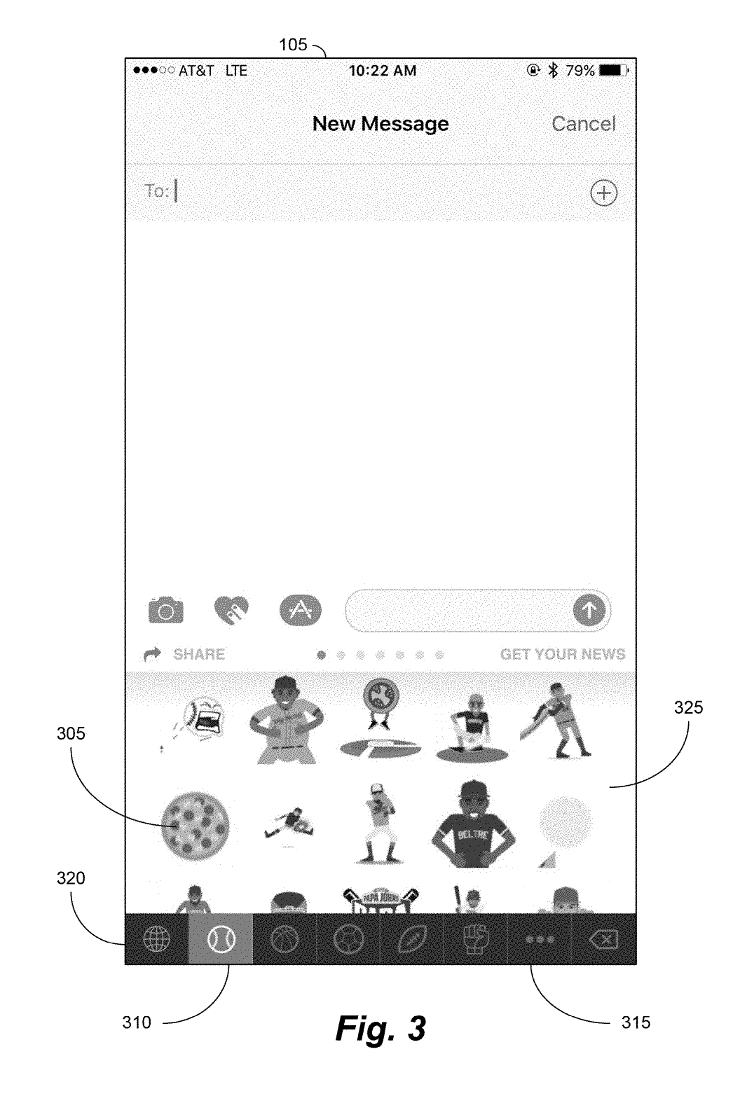

FIG. 3 depicts an exemplary mobile keyboard 325 according to one or more aspects of the disclosed subject matter. The mobile keyboard 325 can be the emoji keyboard displayed via the remote device 105. The mobile keyboard 325 can include a plurality of preview emojis (e.g., preview emoji 305), a keyboard change button 320, content tab buttons (e.g., content tab button 310), and a dynamic button 315. The keyboard change button 320 can allow the user to switch between other keyboards installed on the remote device 105. The content tab button 310 can allow the user to switch between various content tabs within the emoji keyboard by displaying emojis corresponding to the selected tab. The content tabs can include baseball, basketball, soccer, football, fighting, hockey, college football, and the like. When the user selects a content tab 310, the emoji keyboard displays specific content corresponding to that tab. The content can include a grid of emojis and one or more sponsor banners. The user can scroll though the grid vertically. The dynamic button 315 can allow the user to see additional buttons (e.g., content tabs) if the number of buttons exceeds what can be displayed.

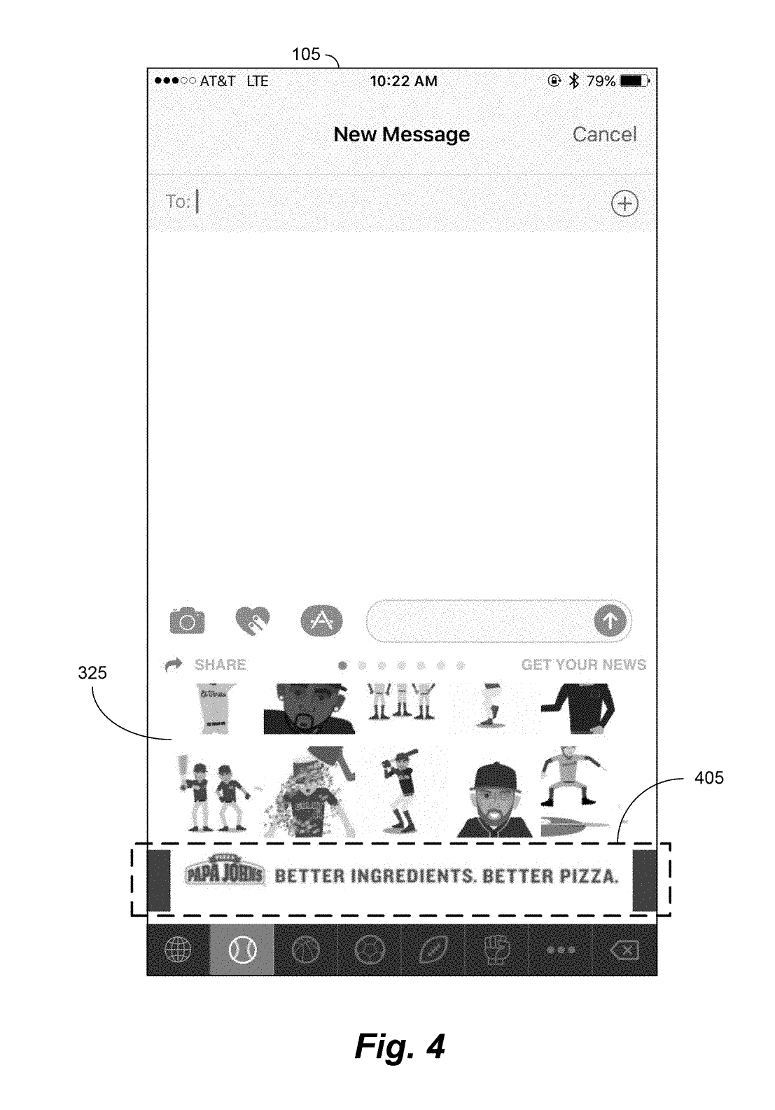

FIG. 4 depicts an exemplary mobile keyboard 325 with an advertisement 405 according to one or more aspects of the disclosed subject matter. The advertisement 405 can be an inline banner. The advertisement 405 can be the width of the keyboard and can appear between the rows of emojis, for example. Additionally, the advertisement 405 can be the width of the keyboard and can appear below the last row of emojis, for example. Additionally, the advertisement 405 may repeat after a predetermined number of rows based on content settings associated with the active content tab (e.g., content tab 310).

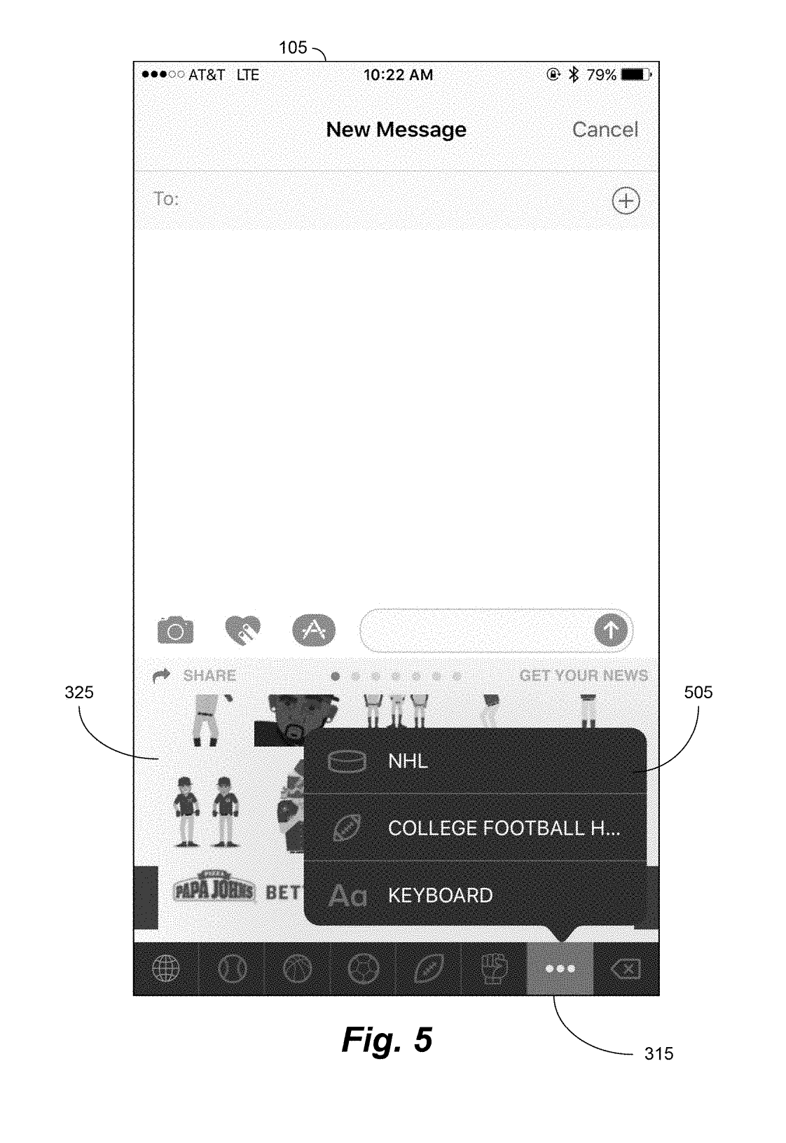

FIG. 5 depicts an exemplary mobile keyboard 325 with additional content tabs expanded according to one or more aspects of the disclosed subject matter. When the dynamic button 315 is selected, additional content tabs may be displayed (e.g., tabs 505). For example, the NHL, college football, and alphanumeric keyboard tabs exceed the number of tabs that could be displayed on the emoji keyboard, but can be accessed via the dynamic tab 315.

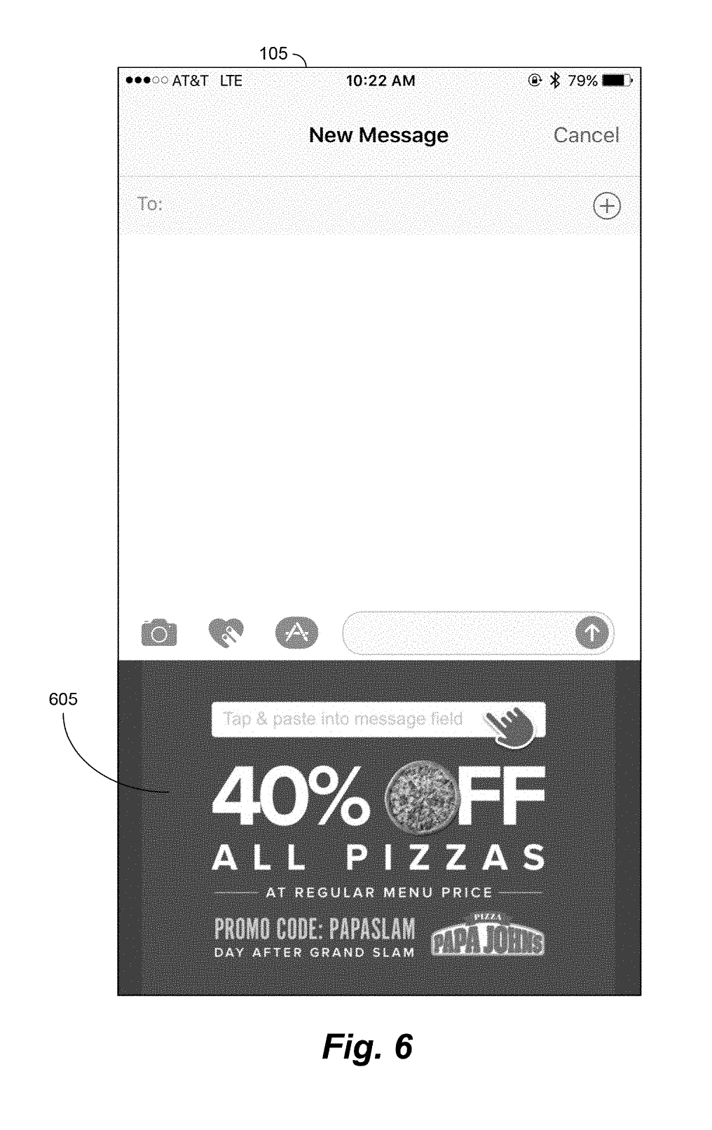

FIG. 6 depicts an exemplary mobile keyboard (e.g., mobile keyboard 325) displaying a temporary advertisement 605 (e.g., “cut and paste” banner asset) according to one or more aspects of the disclosed subject matter. The temporary advertisement 605 can be displayed in response to a user selecting an emoji (e.g., user selects emoji 305). In response to the user selecting an emoji, the entire mobile keyboard (e.g., mobile keyboard 325) temporarily displays an image that can be customized as a digital billboard. The temporary advertisement 605 can be displayed for a predetermined amount of time (e.g., 3 seconds) before returning to the previous state of the mobile keyboard. Additionally, the temporary advertisement 605 can be unique for each content tab 310 of the mobile keyboard 325.

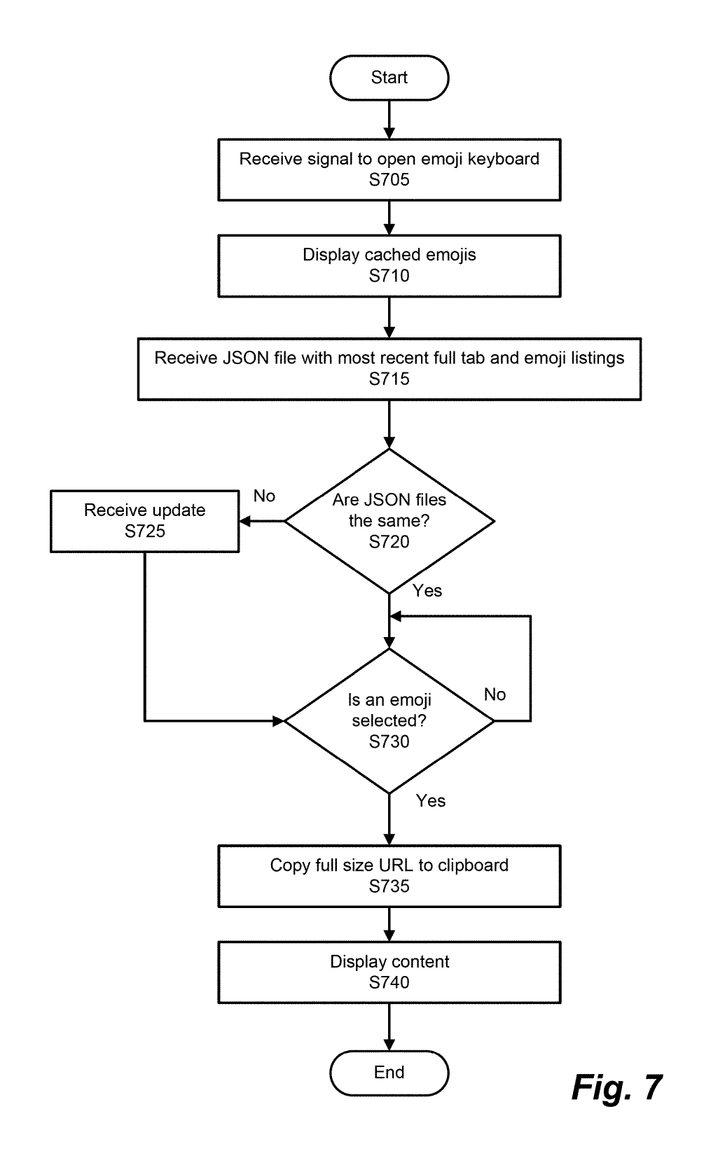

FIG. 7 is an algorithmic flow chart for delivering content via a mobile keyboard 325 according to one or more exemplary aspects of the disclosed subject matter. The process of FIG. 7 can be performed by the remote device 105. Alternatively, or additionally, all or part of the process of FIG. 7 can be performed by the server 110 or another device.

In S705, a signal to open an emoji keyboard (e.g., mobile keyboard 325) can be received. The signal can correspond to a user selecting to activate the emoji keyboard extension, for example.

In S710, cached emojis can be displayed in response to the user opening the emoji keyboard in S705. The cached emojis can be stored locally on the remote device 105, for example.

In S715, a JSON file with the most recent full tab and emoji listings can be received from the server 110. The JSON file can include information corresponding to each content tab 310 and the emoji listings include an encrypted URL for each emoji preview as well as each full size emoji.

In S720, the remote device 105 determines if the JSON file is the same as the previously received JSON file (i.e., the JSON file that was sent the last time the emoji keyboard was opened). The JSON files can be compared by the remote device 105 via the version number, for example. If the JSON files are not the same, then an update can be received in S725 from the server 110. The update can be received via request 260a and reply 260b, for example. After the update is received in S725 from the server 110, the remote device 105 can determine if an emoji is selected in S730. However, if is the remote device 105 determines that the JSON files are the same in S720, then the process can continue to determining if an emoji is selected in S730.

In S730, the remote device 105 can determine if an emoji is selected from the preview emojis displayed via the emoji keyboard associated with the remote device 105. If a preview emoji is not selected, the process can continue checking if an emoji is selected while the emoji keyboard is open. However, if the remote device 105 determines that an emoji is selected, then the URL corresponding to the full size emoji can be used to copy the full size emoji to the clipboard in S735.

In response to the full size emoji being copied to the clipboard in S735, content (e.g., temporary advertisement 605) can be displayed temporarily in place of the emoji keyboard in S740. The content can be displayed for 3 seconds, for example. After the temporary advertisement 605 is displayed for a predetermined amount of time, the process can end.

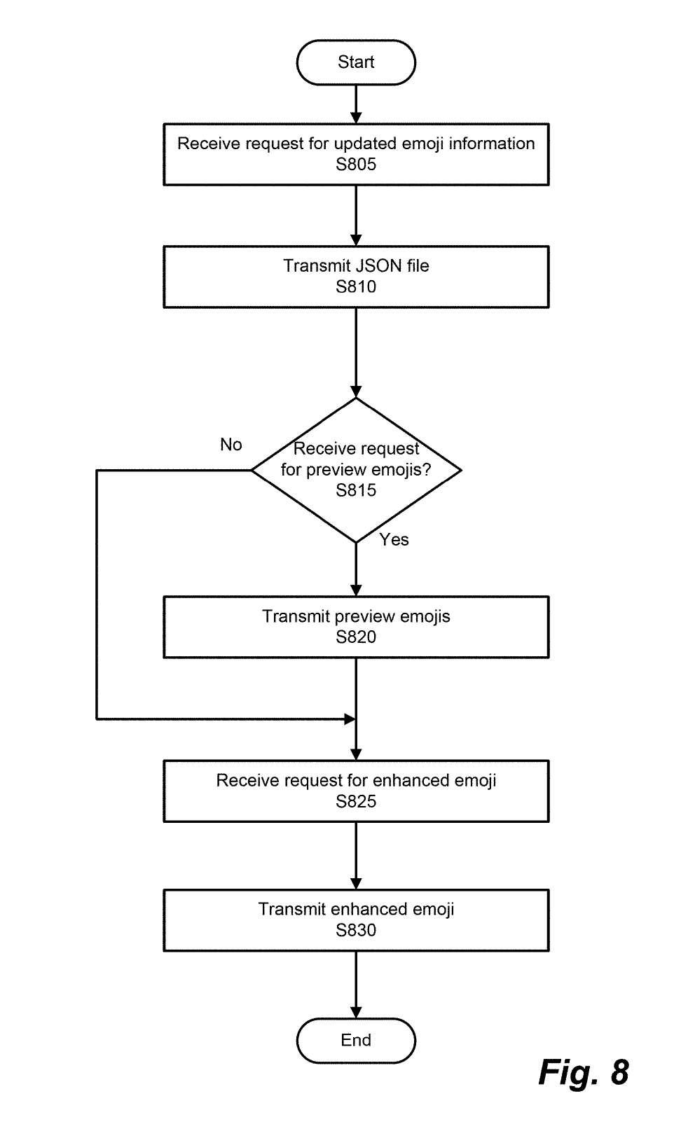

FIG. 8 is an algorithmic flow chart for delivering content via server 110 according to one or more exemplary aspects of the disclosed subject matter. The process of FIG. 8 can be performed by the server 110. Alternatively, or additionally, all or part of the process of FIG. 8 can be performed by the remote device 105 or another device.

In S805, the server 110 can receive a request for updated emoji information can be received (e.g., request 255a).

In S810, the server 110 can transmit a JSON file (e.g., reply 255b) in response to the request for updated emoji information in S805.

In S815, the sever 110 can determine if a request for preview emojis is received. If the server 110 determines that no request for preview emojis is received, the process can continue to receive request for enhanced emoji in S825. However, if the server 110 determines there is a request for preview emojis (e.g., request 260a), the preview emojis can be transmitted in S820 (e.g., reply 260b). The preview emojis can be accessed via an encrypted URL associated with each preview emoji that was passed to the remote device with the JSON file transmitted in S810.

In S825, the server 110 can receive a request for an enhanced emoji (e.g., request 265). The enhanced emoji can be the full size version of a selected preview emoji. The full size version of each emoji can be a larger asset with better quality and resolution than the corresponding preview emoji that was selected.

In S830, the server 110 can transmit the enhanced emoji in response to the request for the enhanced emoji in S825. After the enhanced emoji is transmitted, the process can end.

It should be appreciated that one or more steps of FIG. 7 and FIG. 8 may be performed simultaneously and/or in a different order.

The system 100 can additionally include an engagement tracking feature. Using an analytics tool (e.g., Google Analytics), user interaction can be tracked for each activity in the emoji keyboard. For example, when a tracking event is triggered on the device, the system communicates with servers (such as, for example, Google Analytics servers). In other words, the tracking event is triggered on the device and sent to third party (e.g., Google) server(s). Of course, in one embodiment, the tracking event may be sent to the server 110 which may be equipped with the analytics tool.

Each activity in the emoji keyboard can be assigned a unique event/variable value. Additional events can be triggered via time lapses from an initial event (e.g., 5 seconds elapsed since the initial action, 10 seconds elapsed, 15 seconds elapsed, etc.). This can allow for tracking of the user's navigation habits in addition to their time within specific areas of the emoji keyboard, wherein the information can be queried in 5 second increments. For example, when a user clicks on a content tab 310 (e.g., major league baseball (MLB)), an event is fired every 5 seconds with a label signifying the tab being viewed and the amount of time the user has been viewing the tab. For example, MLB—5 seconds, MLB—10 seconds, MLB—15 seconds. As a result, a query can be generated corresponding to, “How many users stayed in the MLB tab for 10 seconds?” “How many users stayed in the MLB tab for 25 seconds?” This can similarly be done for each content tab 310, for example. Additionally, the data collected can track how much time is spent viewing content in the emoji keyboard. For example, total time spent by all users in a tab can be tracked. The number of times a particular emoji was shared can also be tracked.

The system 100 includes several advantages. For example, separating the preview and full size emojis can significantly improve the operation of the emoji keyboard with respect to memory management, loading the emojis more quickly, optimization of content delivery, and the like. Displaying the preview version of the emojis can allow for more emojis to be loaded and displayed in the emoji keyboard via the remote device 105 compared to the full size emojis that require more storage space due to the increased quality and resolution. Additionally, any animated or Graphics Interchange Format (GIF) version of the emoji may use additional storage space. Therefore, copying the full size emoji to a clipboard in response to a user selecting a corresponding preview emoji can provide a system and method for sharing emojis that takes up significantly less memory because the full size emojis with higher quality and resolution are being copied directly to the clipboard from the server 110, for example. Additionally, the emoji keyboard provides a seamless advertising opportunity within the emoji keyboard. The inline banner asset can be displayed in between rows of emojis and may be repeated. Additionally, because the selected emoji is copied to the clipboard, the entire emoji keyboard can be replaced with an advertisement while the user is pasting the full size emoji from the clipboard. The emoji keyboard can be uniquely used for the temporary advertisement 605 during a time frame where the emoji keyboard does not need to be used so as to not interrupt the user experience. More specifically, the user does not need to interact with the keyboard briefly after selection of the preview emoji as the user pastes the full size emoji, thereby presenting a unique opportunity to display the temporary advertisement 605 without interrupting the user experience.

Additionally, having information such as how much time a user spends in a specific tabbed being queried in intervals of 5 seconds, for example, can allow for unique information in tracking how users are navigating the app. The tracking of the 5 second views can assist in providing advertisers with engagement data, for example, such as how many times their branded emojis and/or advertising banners were viewed for 5 seconds or more. The information can be utilized to determine which tabs are the most popular. For example, the MLB (baseball) tab may be more popular during the baseball season while the NFL tab may be more popular during football season. This information may directly affect how the advertising options are utilized. Further, because the inline banner asset (e.g., advertisement 405) and the temporary advertisement 605 may be different for each content tab 310, there is a significant amount of flexibility in the advertising options available.

In an embodiment, the size of the enhanced emoji can depend on a quality of the connection of the remote device 105 to the network 130. For example, a strong network connection may allow for a larger, higher quality, and/or higher resolution enhanced emoji to be transmitted to the remote device 105. Similarly, a lower quality connection may correspond to transmission of a lower quality enhanced emoji. The quality of the enhanced emoji transmitted can correspond to the quality and/or strength of the network connection between the remote device 105 and the network 130.

In an embodiment, the placement of each preview emoji 305 can be based on various factors including a day of the week, current events, past preferences, a date/time, use metrics, favorite teams, teams currently playing a live game, and the like. For example, several football teams play each other on Sundays during the football season. Accordingly, the preview emoji icons 305 corresponding to the teams currently playing (e.g., teams that kick-off at 1:00 PM) may be placed at the top of the emoji keyboard during the time-frame of that game (e.g., from about 1:00 pm-4:00 pm). Then the emoji positions may change as the 4:15 pm games kick-off. It should be appreciated that the times and schedules are exemplary and can be set to correspond with a known sports schedule.

Additionally, a user's favorite teams (which may have been previously selected via a parent application, for example) may be placed in higher positions on the emoji keyboard.

Similarly, any individual player that may have been prevalent in the news for any reason may be placed in a higher positon on the emoji keyboard due to perceived interest in the individual player.

Further, transmitting an enhanced emoji may be constrained by a type of phone and/or storage availability of the phone.

Additionally, the content tabs 310 may be ordered such that a content tab 310 most relevant to the user is positioned in a first slot, a second most relevant tab in the second slot, and so on. The ordering of the content tabs 310 may be based on a day of the week, current events, past preferences, a date/time, use metrics, favorite teams, user location, trending popularity, overall popularity, teams currently playing a live game, and the like or any combination thereof. The ordering may also be generated for the user by a learning artificial intelligence. For example, if the user spends a majority of his or her time in the basketball content tab, then the basketball content tab may be placed in the first position. Additionally, on the day of the Super Bowl for the National Football League (NFL), the content tab in the first position may be the NFL content tab based on the date/time, for example.

Additionally, the content tabs that are accessed via the dynamic button 315 may be periodically rotated into a more visible position, the more visible position corresponding to a content tab position that is accessible without needing use the dynamic button 315. This may allow a user to increase interaction with a content tab that they may not have been previously familiar with, in addition to increasing the amount of content the user interacts with. Increasing the amount of content the user interacts with may increase advertising opportunities in more content tabs 310, for example.

An aspect of the emoji keyboard (e.g., mobile keyboard 325) includes dynamic ordering of the emojis. The emojis can be ordered dynamically based on various customization options including favorite sports teams, fantasy teams, location of the remote device 105, interacting with the emoji keyboard at predetermined times, and the like, for example, as further described herein.

For example, a selection of one or more favorite sports teams from one or more favorite sports can be selected via the remote device 105. When the favorite teams are selected, the emojis for those teams can appear at the top of each sports section, respectively, in the emoji keyboard. The teams can be selected via a smart phone application (installed on the remote device 105) associated with the emoji keyboard, for example. In an embodiment, the emoji keyboard can be installed on the remote device 105 when the remote device 105 downloads the corresponding smart phone application (which may be referred to herein as the parent smart phone application). The parent smart phone application can include an initial landing page (e.g., registration), a home page, links to an “App Store” (e.g., Apple's App Store, Android's Google Play Store, etc.) In an embodiment, the parent smart phone application can be a sports news and entertainment related smart phone application. In an embodiment, the remote device 105 may select the favorite sports teams through a registration process (e.g., when initially downloading the parent smart phone application). Alternatively or additionally, the favorite teams may be selected later when selecting or editing favorite teams within the parent smart phone application. As an NFL example, the favorite teams selection via the remote device 105 may correspond to the Miami Dolphins as a favorite NFL team so a Jarvis Landry (wide receiver for the Miami Dolphins) emoji can be a first (or highly ranked) emoji displayed in the pro football section of the keyboard. Jarvis Landry may receive this ranking because Jarvis Landry is the only NFL Miami Dolphins emoji currently available and/or unlocked. Alternatively or additionally, a plurality of Miami Dolphins NFL emojis may be available and may be the first, second, third, etc. emojis ranked based on other factors including popularity, alphabetical order, and the like. Similarly, in an NBA example, the favorite teams selection via the remote device 105 may correspond to the Chicago Bulls as a favorite NBA team so Jimmy Butler and Dwyane Wade emojis may be the first emojis displayed in pro basketball section of keyboard on the remote device 105 that made that favorite teams selection. If two or more teams are selected for the same sport, both teams' emojis may appear at the top of the section, with the emojis from the same team being grouped together. The team that is selected first can be displayed first, for example. Additionally or alternatively, the teams may be ranked alphabetically, for example.

After the favorite team's emojis, the order for the emojis may be predetermined based on the JSON file received from the server 110, for example, as described in FIG. 2. Additionally, the emojis may not be displayed twice. For example, if there is a Dwayne Wade emoji in the fifth position in the CMS, but the emoji is already shown among the favorites, the Dwayne Wade emoji may not show up in the fifth position among the remaining emojis because this emoji already appears higher in the keyboard.

In other words, the My Team emojis (e.g., emojis corresponding to selected favorite team(s) for each sport) may simply be moved to the front of each section, respectively.

If the favorite teams selected via the remote device 105 are updated through an “Edit My Teams” options in the parent smart phone application, for example, emojis that are displayed at the top of each keyboard section may also update according to new favorite teams.

In an embodiment, the remote device 105 may de-select Miami Dolphins as a favorite NFL team so Jarvis Landry emoji is no longer the first emoji displayed in pro football section of the keyboard for that remote device 105 (and the Jarvis Landry emoji may return to its original position as determined by server 110). If a new pro football team is selected via the remote device 105 as a favorite, the emojis for that team may be displayed in the first positions corresponding to the number of emojis the keyboard has available for that team. If no favorite NFL team is selected, the emoji order in the pro football section may be set according to the default as defined by the server 110.

A similar scenario may be applied to fantasy sports teams. For example, if a fantasy football team is imported via the remote device 105, the NFL players on the Fantasy Team who have emojis available in the emoji keyboard may be displayed at the top of the pro football section of the keyboard. Similarly, the same may be true for other fantasy team's imports (e.g., basketball, baseball, etc.). In an embodiment, when the favorite teams have been selected and the fantasy teams have been imported, the fantasy player emojis may appear after player emojis from the favorite teams if the remote device 105 has selected a favorite team and Fantasy Team for the same sport, for example.

In an embodiment, if an emoji that is both on one of the selected favorite teams and an imported fantasy team, that individual player emoji may only appear one time and not be repeated; it may appear first with the other favorite team's emojis and not with the fantasy team emojis. The order in which the player emojis appear for the Fantasy Team at the top of the sport section of the keyboard may be determined alphabetically by last name, for example.

In an embodiment, if more than one Fantasy Team is imported for a sport, the fantasy players from each of the Fantasy Teams may appear at the top of the keyboard, with the fantasy players for each specific Fantasy Team grouped together. The Fantasy Team imported first may be displayed first, for example.

In an embodiment, if a roster of the imported Fantasy Team changes over time (e.g., information about fantasy rosters being updated can be found through ESPN, Yahoo, and CBS Sports via web crawling, and/or through the Fantasy Team being edited on the parent smart phone application), the players displayed at the top of the keyboard for the Fantasy Team may also update accordingly.

For example, if Cam Newton starts the season on the Fantasy Team, the corresponding Cam Newton emoji may appear at the top of the pro football section of the emoji keyboard. However, if Cam Newton is traded in the corresponding fantasy league (e.g., the fantasy team indicated at the remote device 105 no longer has Cam Newton on the fantasy team), the Cam Newton emoji may no longer appear in the personalized portion of the pro football section of the keyboard (e.g., an exception may be if the remote device 105 selected the Carolina Panthers as one of the favorite NFL teams then the Cam Newton emoji may still appear in the personalized portion). In an embodiment, if a new player is added to the Fantasy Team that was not previously on the Fantasy Team, the emoji for that player may appear at the top of the pro football section of the emoji keyboard as long as the player remains on the Fantasy Team and the Fantasy Team imported into the parent smart phone application via the remote device 105.

In an embodiment, if the Fantasy Team is deleted, the personalized set of fantasy player emojis at the top of the keyboard corresponding to the Fantasy Team may also be removed as a result.

In an embodiment, to further notify the remote device 105 of potential keyboard personalization, the initial landing page can be updated with information including selection of one or more favorite teams can correspond to the emoji keyboard of the remote device 105 being personalized based on the favorite team selections. The landing page may also feature an animated emoji from the collection.

In an embodiment, a pop-up indication may be utilized after selection of the favorite teams. The pop-up indication may indicate that the emojis corresponding to the favorite team's selection may be displayed at the top of each corresponding sport section in the emoji keyboard. The pop-up indication may feature an animated emoji from one of the selected favorite teams. For example, the emoji may be selected based on the first team selected.

Additionally, a pop-up may be utilized when the remote device 105 has already downloaded the smart phone parent application to indicate that the emojis for the favorite teams and/or fantasy teams may appear at the top of each corresponding sports section in the emoji keyboard. The pop-up indication may feature an animated emoji from the favorite teams selection. For example, the animated emoji may be selected based on the first favorite team selected when selecting favorite teams.

In an embodiment, the server 110 may be utilized to assist the remote device 105 in more accurately sorting and finding emojis. For example, additional fields may be added for each emoji (e.g., via metadata). For example, each emoji may include a label that identifies that emoji as belonging to a certain team. For example, LeBron James and Kyrie Irving emojis may be labeled as emojis for the “Cleveland Cavaliers”. The new label may be labeled through a new “team” field in the server 110, for example.

Additionally, the server 110 may recommend team names as the remote device 105 receives input in a search field, for example, to avoid mix-ups with entering team names. The team name data can be pulled from data previously stored at the server 110 (or a databased associated with the server 110). Alternatively or additionally, such data may be pulled from third-party entities (such as, for example, SportsDirect). In one embodiment, emojis may only be labeled to one team at a time.

For fantasy team personalization in the keyboard, a field for “Player Name” can be included where the CMS can recommend player names as the remote device 105 receives input corresponding to the player name for the sport the emoji belongs to (to avoid mix-ups with entering player names). The player names may also be pulled as discussed above with respect to the team name data.

Sponsored emojis may have predetermined placements within the order of emojis displayed per sport section, even if a favorite team and/or fantasy team is selected/imported. For example, Papa John's emojis may appear in the 3rd, 6th, and 10th positions for each remote device 105 (this can be determined on a case-by-case basis for each sponsor), even if a favorite team is selected and/or a fantasy team is imported and those personalized emojis would normally be in the 3rd, 6th, and 10th positions, each will get moved to the next position if a sponsored emoji is occupying that position.

Various rewards and in-app purchases may be utilized to provide additional functionality. For example, the in-app purchases may be purchased through an emoji store, which may be incorporated in or an extension of a built-in “App Store” or through a separate executable application emoji store. In an embodiment, the emoji store may be accessed through the emoji keyboard and/or parent smart phone application through various links disposed in predetermined locations.

In an embodiment, a banner can be placed within the emoji keyboard and/or parent smart phone application such that the banner can be closed via one or more predetermined instructions from the remote device 105 (e.g., the remote device may receive a touch input corresponding to a selection to close the banner) so it does not appear again. The banner may include a 24-hour countdown until a next emoji is available as a reward, for example. Alternatively or additionally, the 24-hour countdown may begin once a previously unlocked emoji is claimed by the remote device 105. This may repeat until the remote device 105 has unlocked all available emoji rewards, at which point countdowns may stop until more emoji rewards become available. Rewards may be accessed through various interactions with the emoji keyboard and/or the parent smart phone application. For example, using the emoji keyboard and/or application at least once per day (e.g., at least once per 24 hours) may be the minimum requirement to receive the award.

The banner may be the same width as content cards and height would be less by 50%. The banner may also include an emoji animation selected from the existing set of emojis. The content cards can display content in a newsfeed, for example. The newsfeed may appear in the parent smartphone application, for example. The content may include text, images, and/or video related to the user's favorite teams or fantasy teams. The content cards can be square in shape (however, they can be of any other shape). The emoji animation can be displayed via the banner, and the banner can be presented between two other content cards towards a top of the newsfeed, for example.

In an embodiment, the emoji keyboard layout may include “Get New Emojis” in a top right corner of the emoji keyboard. “Get New Emojis” in the emoji keyboard may link to the Emoji Store home page within the parent smart phone application.

In an embodiment, the emoji keyboard may also distinguish between active/inactive emojis displayed in the emoji keyboard. Inactive emojis may be emojis that are not accessible but are available for purchase and/or are able to be unlocked through various interactions with the keyboard and/or parent smart phone application. Inactive emojis may appear in grayscale, for example, to distinguish between active emojis. However, the inactive/grayscale emojis may still be animated/looped so the emoji animations can still be viewed on the remote device 105. Inactive emojis may prompt the remote device 105 to make purchases in the Emoji Store when the inactive emoji is selected.

If an inactive emoji is selected, a pop up with more information on getting that emoji may be displayed. The additional information may include the Emoji name, a larger view of the animated emoji on loop, and the purchasing and/or unlocking options, for example.

If an inactive emoji is selected in the emoji keyboard, the remote device 105 may be linked to the pop-up for that emoji in the Emoji Store in the parent smart phone application, for example.

Alternatively or additionally, when an inactive emoji is selected that can be purchased (e.g., NFL, NCAAF, MLB, MLS emojis, etc.) a pop-up to purchase the emoji may be displayed with different purchasing options. For example, the emoji may be purchased as an individual emoji for a first predetermined price or a pack of related emojis for a second predetermined price. The pack of emojis may include a team pack, which would include any emojis associated with the team of the selected emoji and/or a championship pack, which may include several emojis from championship teams, for example.

Individual emojis can be, but are not necessarily, available in packs. However, all emojis that are in packs may be available as individual emoji purchases. Additionally, if there is no emoji pack containing the selected inactive emoji, this second “Emoji Pack” option may not be available.

Further, a subscription may be purchased to access all league emojis for a predetermined price per month, which may include all future emojis that are released.

When an inactive emoji is selected that can be unlocked but not purchased, a pop-up with a message for how to unlock the emoji may be displayed. For example, the message for how to unlock the emoji may have a countdown timer for how long the parent smart phone application may be visited to unlock the reward to receive that emoji.

Emojis that can be purchased may be separate from emojis that can be unlocked. For example, these two types of emojis may be distinguished by who owns/licenses the rights to monetize the emoji, for example.

The server 110 may sort the free/inactive emojis that are displayed following the personalized emojis (e.g., favorite teams, imported fantasy teams, etc.).

The sorting may include separating free/inactive emojis to be displayed after the personalized emojis and purchased emojis, for example. Additionally, sponsored emojis may have predetermined positions even if the remote device 105 has personalized/purchased/unlocked emojis. For example, Papa John's emojis may be in the 3rd, 6th, and 10th positions for all remote devices 105 even if each remote device 105 has personalized/unlocked emojis.

Additionally, the emojis in the emoji keyboard can be further sorted based on date of purchase (e.g., for purchased emojis), emoji personalization, order of emojis via CMS, and the like. In an embodiment, the emojis can be ordered as follows:

The emoji keyboard may begin with purchased emojis (e.g., from most recently purchased to oldest purchased, with most recent emojis purchased at top of keyboard). Purchased emojis may go before the “My Teams” (e.g., favorite teams selected by the remote device 105) and Fantasy Team emojis for the fantasy teams imported via the remote device 105.

In the example that the remote device 105 purchases an entire sport via subscription, the order of the emojis may be: My Teams emojis, Fantasy Team emojis, followed by emojis ordered by the server 110 (e.g., no need to bump emojis purchased to the top since all locked emojis will be “purchased” at once if it is via subscription). In other words, “purchased” emojis may simply change from grayscale to active in their positions set via the server 110.)

Next, the My Teams emojis can follow the purchased emojis.

Next, the Fantasy Team emojis can follow the My Teams emojis.

Next, free/inactive/unlocked emojis can follow the Fantasy Team emojis, wherein the free/inactive/unlocked emojis can be ordered in a predetermined order via the server 110. Unlocked emojis (e.g., emojis that are earned, not purchased) may simply change from being inactive/grayscale to being active (e.g., the remote device 105 can send the emoji) at their positions as determined via the server 110.

The emojis may also appear in a predetermined order in the Emoji store that can be accessed from the emoji keyboard and/or the parent smart phone application. For example, the Emoji Store order per sport can be the same as the order set manually for the emoji keyboard via the server 110. For example, there may be a mix of locked and unlocked emojis as the remote device 105 views the emojis that can be purchased (e.g., this may allow the remote device 105 to distinguish between emojis that are already owned and the emojis that can be purchased to add to the collection of the remote device 105. There may be one predetermined order set per sport which may be the same for the emoji keyboard and for the Emoji Store. Once an emoji is rewarded or purchased it may be permanently in the emoji keyboard of the remote device 105 (i.e., the emoji cannot be revoked). Emojis acquired via subscription may also be included in this rule even if the remote device 105 stops paying the monthly subscription. However, if a subscription is canceled, the remote device 105 may not receive any future emojis for the sport unless the remote device 105 re-subscribes for that sport.

The emoji keyboard may also include the feature to add/remove/arrange emojis within a tab. For example, the content delivery system (e.g., the server 110) may configure if the emoji is purchasable, free, and/or a reward. If purchasable, the system may have the ability to configure if the emoji will belong to a pack or be a solo purchase. All purchasable emojis may be available individually (but may not necessarily be purchasable as part of a pack). In an embodiment, purchasable emojis' may not be part of gamification rewards because that may cause a conflict when looking to see what emojis have been purchased. For example, the purchased emojis may be stored on third party servers (e.g., Apple, Inc.) and only updated when an emoji or emoji pack is purchased, for example. Free emojis may also be similarly accounted for when they are “purchased” even though there is not a monetary exchange.

Additionally, the free, inactive, and sponsored emojis may be sorted with predetermined positioning.

The in-app purchases may also include items and/or packs available for purchase. For example, four predetermined emojis may be part of a “2017 Final Four Pack”, where the four emojis may relate to the teams that were in the 2017 Final Four. Emojis that are in packs may also be available for purchase individually. However, not all individual emojis may be available in a pack.

Additionally, the system may include custom push notifications for special event emojis. These push notifications may be custom written and may alert the remote device 105 that there are new emojis in the emoji keyboard around certain events (e.g., Super Bowl, Final Four, etc.). In an embodiment, the push notifications may include a graphic and/or animation of the new emojis (e.g., as an attachment similar to when a photo is texted between smart phones).

The link to the Emoji Store may open the Emoji Store to a certain page (e.g., either a page with the new unlocked emoji or a page with an emoji or emoji pack that can be purchased). The page that is opened may show the animated unlocked/purchasable emoji.

Alternatively or additionally, the Emoji Store within the parent smart phone application may display a list of purchasable content and emoji portfolio per sport. Additionally, the emojis may be displayed differently depending on whether or not the content has already been purchased or if the content is still available to purchase. The emojis displayed for purchase may include an item detail section that can display a preview of what can be purchased.

Further, bundles or single packs of emojis may be customized via the server 110.

The Emoji Store may be integrated with iTunes In-App purchases, for example.

Further, the system may include in-app purchases management outside of the server 110 with a customer relationship manager (CRM).

The CRM may store purchases made by the remote device 105 so the emoji keyboard unlocks the corresponding emojis. The CRM may be communicably coupled to the account information (associated with a user, for example) of the remote device 105, for example. If the remote device 105 initially declines to “sign up” with email or social account in registration process, the remote device 105 may be required to sign up when trying to make a purchase. An advantage of this setup includes the user being able to start using a new (or different) remote device 105 and maintain access to previously stored information.

The mobile keyboard content delivery system may also include gamification. For example, the remote device 105 may be rewarded with an emoji when opening the application at least once every 24 hours (e.g., the clock resets after the remote device 105 unlocks and collects the emoji). In an embodiment, the remote device 105 is notified when this happens. Additionally, the remote device 105 may be sent an automated, personalized push notification when unlocking a new emoji. This may encourage the remote device 105 to visit the application to claim the unlocked emoji. For example, the push notification may read, “Congrats! You just unlocked the [Emoji Name] emoji. Text it to a friend.” The push notification may also link to the Emoji Store with a pop-up about the specific unlocked emoji. Additionally, if the remote device 105 opens the application later (i.e., not through a push notification) after the 24-hour period expires, an in-app pop-up about the emoji reward may still be displayed.

For example, the pop-up may display the emoji with a message including the emoji name with various options including an option to purchase more emojis, an option to close pop-up, and an option to stop pop-up notifications about emoji rewards going forward. Weekly e-mails may be sent to each remote device 105 (or account that has been previously set up) as a reminder of daily rewards. When the application is opened to qualify for the reward, opening the application may include opening the main smart phone application and/or the emoji keyboard. Once the remote device 105 unlocks an emoji by opening the application, that emoji goes from grayscale to active in the keyboard and Emoji Store automatically. In an embodiment, the remote device 105 may be rewarded with a first emoji during a Sign Up process. For example, an emoji pop-up may appear after the remote device 105 has signed up with email or social media account and before keyboard instructions appear. The message may reappear every 24 hours for a new emoji.

The order in which the emojis are rewarded may be randomized from a predetermined set of emojis marked as “rewards”. The “reward” set of emojis can be hardcoded for predetermined amounts of time. For example, during the Super Bowl, specific emojis relating to the teams participating in the Super Bowl may be unlocked. The emojis that are unlocked around certain events (i.e., predetermined times of the year) may not need to be set up as rewards. Rather, the emojis may simply appear as usable on the keyboard on a certain date, for example, and the remote device 105 may see a pop-up corresponding to the new usable emojis in the parent smart phone application the next time the parent smart phone application is visited by the remote device 105 (e.g., this notification may be separate from the 24-hour emoji rewards).

The push notifications may include additional features including automatic notifications every 24 hours after the remote device 105 has claimed previous emoji rewards. Additionally, the remote device 105 may have the ability to turn off these notifications in the parent smart phone application, for example. The push notifications may include custom notifications for special event emojis. These notifications may be custom written and inform the remote device 105 that there are new emojis in the keyboard around certain events (i.e., Super Bowl, Final Four, etc.) The remote device 105 may also have the ability to turn off these notifications.

The mobile keyboard content delivery system may also include analytics relating to the Emoji Store. For example, the system may include analytics for all Emoji Store pages and emoji pop-ups (e.g., via Google Analytics). The analysis may include associating a user to his/her identification when be/she is, using the keyboard extension in another application. The analysis may further include tracking an application that is using the emoji keyboard extension at the time the emoji is clicked.

Further, advertising integration may provide the ability to click out of advertisements within the keyboard to web pages.

Additionally, each emoji may be compatible with any application that can receive content pasted from a clipboard (e.g., Instagram, Facebook messenger, WhatsApp, etc.)

Additionally, the mobile keyboard content delivery system may optimize the delivery of the image assets (e.g., best quality vs. smallest size). For example, the emojis may be larger when tweeted (e.g., via Twitter) and sent through Facebook Messenger, for example, but may be 110×110 pixels when texted.

Additionally, a reward system may include points for sending emojis. For example, the remote device 105 may receive more points for sending to an emoji to a group chat because more people will see the emoji. Alternatively or additionally, the remote device 105 can receive more points for sending the emoji on Facebook/Instagram/etc. Additionally, the remote device 105 may receive an increased amount of points (e.g., increased relative to just sending one emoji to one person with no other options for point increases) when sending an emoji during a game if the sent emoji corresponds to a player playing in that game Additionally, the remote device 105 may receive more points when sending the emoji at a predetermined location (e.g., at a stadium/arena when the emoji is a player currently playing at that stadium/arena (i.e., location based points)). Alternatively or additionally, the remote device 105 may receive an increased amount of points at a sports bar. The more/increased amount of points may be predetermined in the CMS, for example.

In an embodiment, the emoji keyboard can include emojis with sound. For example, when a user sends an emoji with sound, the receiving end of the message may be able to hear the sound coming from the emoji when the emoji is viewed in the messaging conversation. Further, the sound may be able to be replayed via a predetermined command on the device that received the emoji with sound. In an embodiment, the sound from the emoji with sound may loop continuously while the emoji animation loops, for example. Additionally, the sound may stop playing when the emoji is no longer visible on the display of the device that received the emoji with sound, for example.

Monetization can be an advantageous aspect of the mobile keyboard content delivery system. As the emoji keyboard may be used frequently, the emoji keyboard may provide an ideal location for advertising. In an embodiment, more than one sponsor may be featured via the emoji keyboard such that the sponsors received balanced visibility corresponding to the amount of money payed fort the sponsorship. For example, Papa John's and Pepsi may both buy a sponsorship to advertise in the NFL section of the emoji keyboard during Super Bowl weekend. Papa John's sponsorship may correspond to $75,000 while Pepsi's sponsorship may correspond to $25,000. As a result, Papa John's emojis, banners (e.g., advertisement 405), and “cut and paste” banner asset (e.g., temporary advertisement 605) may appear 75% of the time while Pepsi's emojis, banners (e.g., advertisement 405), and “cut and paste” banner asset (e.g., temporary advertisement 605) may appear 25% of the time. Each brand may not appear in the emoji keyboard simultaneously (e.g., a Papa John's banner and a Pepsi banner may not be displayed in the same screen of the remote device 105). Additionally, the rotation of the sponsors may be randomized such that each sponsor appears fairly throughout the predetermined time frame (e.g., throughout Super Bowl weekend as well as during key moments of the game.) Key moments of the game may be when a player from one of the teams scores a touchdown, the emoji keyboard may see a temporary increase in selection of the emoji corresponding to the player who just scored the touchdown. As a result, the sponsors may be balanced such that each may be displayed during key moments even though one sponsor may own a majority of the appearance percentage (e.g., 75% compared to 25%). These features may be performed by the server 110.

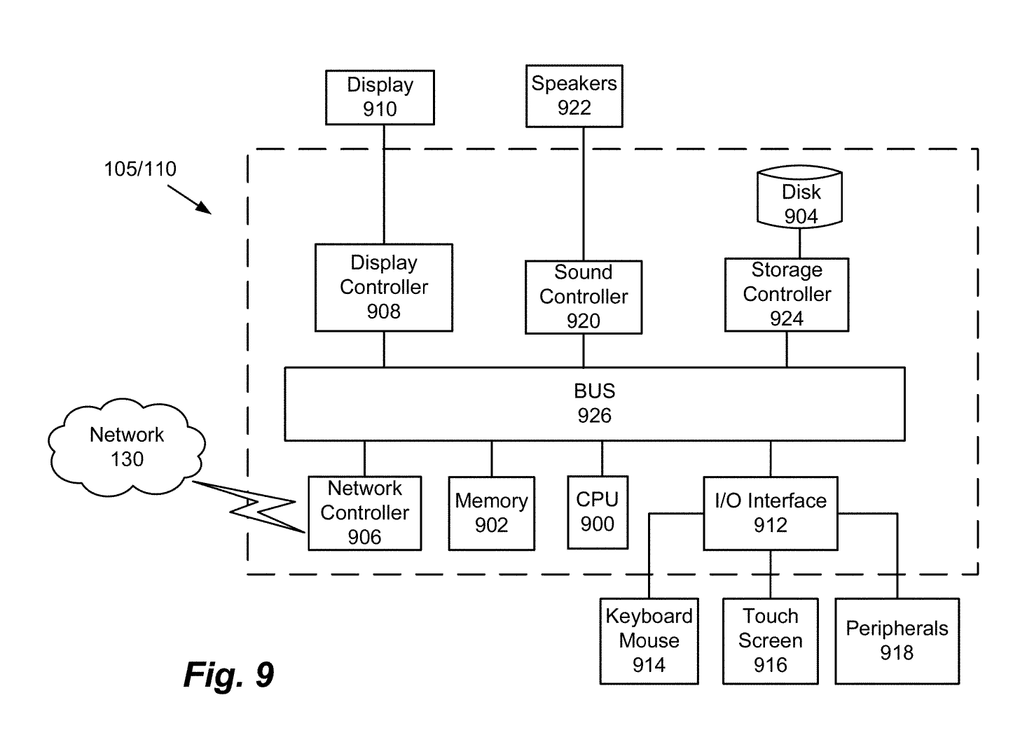

Next, a hardware description of a computer/device (such as the server 110) according to exemplary embodiments is described with reference to FIG. 9. The hardware description described herein can be a hardware description of the remote device 105. In FIG. 9, the server 110 (and/or the remote device 105) includes a CPU 900 which performs one or more of the processes described above/below. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 110 (and/or the remote device 105) communicates, such as a server or computer.

Further, the claimed advancements may be provided as a utility application, background daemon, or component of an operating system, or combination thereof, executing in conjunction with CPU 900 and an operating system such as Microsoft Windows, UNIX, Solaris, LINUX, Apple MAC-OS and other systems known to those skilled in the art.

The hardware elements in order to achieve the server 110 (and/or the remote device 105) may be realized by various circuitry elements. Further, each of the functions of the above described embodiments may be implemented by circuitry, which includes one or more processing circuits. A processing circuit includes a particularly programmed processor, for example, processor (CPU) 900, as shown in FIG. 9. A processing circuit also includes devices such as an application specific integrated circuit (ASIC) and conventional circuit components arranged to perform the recited functions.

In FIG. 9, the server 110 (and/or the remote device 105) includes a CPU 900 which performs the processes described above. The server 110 (and/or the remote device 105) may be a general-purpose computer or a particular, special-purpose machine. In one embodiment, the server 110 becomes a particular, special-purpose machine when the processor 900 is programmed to perform mobile keyboard content delivery (and in particular, any of the processes discussed with reference to FIGS. 7 and 8).

Alternatively, or additionally, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The server 110 (and/or the remote device 105) in FIG. 9 also includes a network controller 906, such as an Intel Ethernet PRO network interface card from Intel Corporation of America, for interfacing with network 130. As can be appreciated, the network 130 can be a public network, such as the Internet, or a private network such as an LAN or WAN network, or any combination thereof and can also include PSTN or ISDN sub-networks. The network 130 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 110 (and/or the remote device 105) further includes a display controller 908, such as a graphics card or graphics adaptor for interfacing with display 910, such as a monitor. A general purpose I/O interface 912 interfaces with a keyboard and/or mouse 914 as well as a touch screen panel 916 on or separate from display 910. General purpose I/O interface also connects to a variety of peripherals 918 including printers and scanners.

A sound controller 920 is also provided in the server 110 (and/or the remote device 105) to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the server 110 (and/or the remote device 105). A description of the general features and functionality of the display 910, keyboard and/or mouse 914, as well as the display controller 908, storage controller 924, network controller 906, sound controller 920, and general purpose I/O interface 912 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset.

The functions and features described herein may also be executed by various distributed components of a system. For example, one or more processors may execute these system functions, wherein the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

Having now described embodiments of the disclosed subject matter, it should be apparent to those skilled in the art that the foregoing is merely illustrative and not limiting, having been presented by way of example only. Thus, although particular configurations have been discussed herein, other configurations can also be employed. Numerous modifications and other embodiments (e.g., combinations, rearrangements, etc.) are enabled by the present disclosure and are within the scope of one of ordinary skill in the art and are contemplated as falling within the scope of the disclosed subject matter and any equivalents thereto. Features of the disclosed embodiments can be combined, rearranged, omitted, etc., within the scope of the invention to produce additional embodiments. Furthermore, certain features may sometimes be used to advantage without a corresponding use of other features. Accordingly, Applicant(s) intend(s) to embrace all such alternatives, modifications, equivalents, and variations that are within the spirit and scope of the disclosed subject matter.

1. An apparatus, comprising:
processing circuitry configured to
receive a request from a remote device via a network for updated emoji information, the updated emoji information being configured to populate an emoji keyboard,
transmit a file via the network in response to the request for updated emoji information, the file corresponding to the updated emoji information and including emoji listings, the emoji listings corresponding to preview emoji icons and enhanced emoji icons,
determine whether a request for the preview emoji icons is received,
transmit the preview emoji icons to the remote device via the network in response to receiving the request for the preview emoji icons,
receive a request from the remote device via the network for an enhanced emoji icon from the enhanced emoji icons, the enhanced emoji icon being an enhanced version of a corresponding preview emoji icon, the enhanced emoji icon and the corresponding preview emoji icon representing a same content, and
transmit the enhanced emoji icon to the remote device via the network in response to receiving the request for the enhanced emoji icon.

2. The apparatus of claim 1, wherein the emoji keyboard includes a plurality of content tabs, each content tab including a predetermined number of preview emoji icons displayed in a predetermined order.

3. The apparatus of claim 1, wherein the emoji listings include an encrypted Uniform Resource Locator (URL) for each preview emoji icon and each enhanced emoji icon.

4. The apparatus of claim 3, wherein the enhanced emoji icon is a full size version of the corresponding preview emoji icon, the enhanced emoji icon including one or more of higher quality, larger size, and higher resolution.

5. The apparatus of claim 1, wherein the enhanced emoji icon is transmitted to a clipboard feature of the remote device, the enhanced emoji icon being pasted from the clipboard feature.

6. The apparatus of claim 1, wherein the emoji keyboard includes one or more inline banner assets displayed between rows of preview emoji icons.

7. The apparatus of claim I, wherein the processing circuitry is further configured to instruct the remote device to display additional content that is different from the content of the preview and enhanced emoji icons, in response to the request for the enhanced emoji icon, the request for the enhanced emoji icon being initiated when the preview emoji icon is selected.

8. The apparatus of claim 7, wherein the processing circuitry is further configured to instruct the remote device to display the additional content for a predetermined amount of time before returning to a previous state of the emoji keyboard.

9. The apparatus of claim 7, wherein the additional content is displayed in place of the emoji keyboard.

10. A method, comprising:
receiving, via processing circuitry, a request from a remote device via a network for updated emoji information, the updated emoji information being configured to populate an emoji keyboard;
transmitting, via the processing circuitry, a file via the network in response to the request for updated emoji information, the file corresponding to the updated emoji information and including emoji listings, the emoji listings corresponding to preview emoji icons and enhanced emoji icons;
determining, via the processing circuitry, whether a request for preview emoji icons is received;
transmitting, via the processing circuitry, the preview emoji icons to the remote device via the network in response to receiving the request for the preview emoji icons;
receiving, via the processing circuitry, a request from the remote device via the network for an enhanced emoji icon from the enhanced emoji icons, the enhanced emoji icon being an enhanced version of a corresponding preview emoji icon, the enhanced emoji icon and the corresponding preview emoji icon representing the same content; and
transmitting, via the processing circuitry, the enhanced emoji icon to the remote device via the network in response to receiving the request for the enhanced emoji icon.

11. The method of claim 10, wherein the emoji keyboard includes a plurality of content tabs, each content tab including a predetermined number of preview emoji icons displayed in a predetermined order.

12. The method of claim 10, wherein the emoji listings include an encrypted Uniform Resource Locator (URL) for each emoji preview icon and each enhanced emoji icon.

13. The method of claim 12, wherein the enhanced emoji icon is a full size version of the corresponding preview emoji icon, the enhanced emoji icon including one or more of higher quality, larger size, and higher resolution.

14. The method of claim 10, further comprising:
transmitting the enhanced emoji icon to a clipboard feature of the remote device, the enhanced emoji icon being pasted from the clipboard feature.

15. The method of claim 10, wherein the emoji keyboard includes one or more inline banner assets displayed between rows of the preview emoji icons.

16. The method of claim 10, further comprising:
displaying additional content that is different from the content of the preview and enhanced emoji icons in the emoji keyboard, in response to the request for the enhanced emoji icon, the request for the enhanced emoji icon being initiated when the preview emoji icon is selected.

17. The method of claim 16, further comprising:
displaying the additional content for a predetermined amount of time before returning to a previous state of the emoji keyboard.

18. The method of claim 16, wherein the additional content is displayed in place of the emoji keyboard.

19. A non-transitory computer-readable storage medium storing computer-readable instructions thereon which, when executed by a computer, cause the computer to perform a method, the method comprising:
receiving a request from a remote device via a network for updated emoji information, the updated emoji information being configured to populate an emoji keyboard;
transmitting a file via the network in response to the request for updated emoji information, the file corresponding to the updated emoji information and including emoji listings, the emoji listings corresponding to preview emoji icons and enhanced emoji icons;
determining whether a request for preview emoji icons is received;
transmitting the preview emoji icons to the remote device via the network in response to receiving the request for the preview emoji icons;
receiving a request from the remote device via the network for an enhanced emoji icon from the enhanced emoji icons, the enhanced emoji icon being an enhanced version of a corresponding preview emoji icon, the enhanced emoji icon and the corresponding preview emoji icon representing the same content; and
transmitting the enhanced emoji icon to the remote device via the network in response to receiving the request for the enhanced emoji icon.

20. The non-transitory computer-readable storage medium of claim 19, wherein the emoji keyboard includes a plurality of content tabs, each content tab including a predetermined number of preview emoji icons displayed in a predetermined order, and
wherein the emoji listings include an encrypted URL for each emoji preview icon and each enhanced emoji icon.
